(19) United States
(12) Patent Application Publication
(10) Pub. No.: US 2012/0160780 A1
(43) Pub. Date: Jun. 28, 2012

(54) METHOD FOR INHIBITION OF BROMATE FORMATION IN OZONATION OF WATER

(76) Inventors: B. KEEL ROBINSON, Richmond, CA (US); NIKHIL D. SHETH, Carol Stream, IL (US); RICARDO J. VILLALOBOS, San Francisco, CA (US)

(21) Appl. No.: 13/227,266

(22) Filed: Sep. 7, 2011

Related U.S. Application Data
(60) Provisional application No. 61/381,416, filed on Sep. 9, 2010.

(51) Int. Cl. C02F 1/78

(52) U.S. Cl. 210/760; 210/198.1

(57) ABSTRACT

The formation of bromate (BrO₃⁻) from bromide ion in water during ozone treatment of the water is inhibited by inclusion of a compound of formula I:

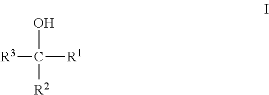

where each of R¹ and R² is an oxygen-containing electron-withdrawing substituent effective to resonance stabilize an alkoxy radical of compound I, and R³ is an alkyl, aryl, or aralkyl group. The water may be further treated with an additional oxidant such as hydrogen peroxide. The compound of formula I is effective to inhibit formation of bromate from bromide present in the water, without impairing the oxidative remediation of the water.

### CROSS-REFERENCE TO RELATED APPLICATION

This application claims priority to U.S. provisional application Ser. No. 61/381,416, filed Sep. 9, 2010, which is hereby incorporated by reference in its entirety.

### TECHNICAL FIELD

The method relates to inhibition of bromate formation during oxidation of bromide ion-containing waters with ozone and/or hydrogen peroxide. More particularly, the method relates to the use of compounds which are effective to inhibit bromate formation without impeding desired oxidation of contaminants and/or disinfection by the oxidizing reagents.

### BACKGROUND

Ozonation is increasingly used in water treatment processes, e.g. for destruction of chemical contaminants and pathogens, color removal, and/or disinfection. However, an undesired side reaction of ozonation in water containing bromide ion (Br⁻) is oxidation of bromide to intermediate brominated species, i.e. hypobromite (OBr⁻) and hypobromite radical, and eventually to bromate (BrO₃⁻), a suspected carcinogen. The U.S. EPA Stage I Disinfectants/Disinfection By-Products rule sets a limit of 10 μg/L for bromate.

Various approaches have been used to minimize such bromate formation, or to reduce bromate once formed back to bromide. See, for example, the review by R. Butler et al., Critical Reviews in Environmental Science and Technology, 35:193 (2005). In one approach, the formation of bromate is reduced by adjusting the water pH to <5, which converts the first oxidation product of bromide to hypobromous acid, which is not oxidizable to bromate (U. von Gunten, Y. Oliveras, Water Res. 31:900 (1997)). In other approaches, ammonium ion is added to tie up the bromide, or an organic carbon source is added to react with the ozone (U. von Gunten and J. Hoigné, Environ. Science and Technology 28:1234 (1994)). However, these approaches can compromise oxidation efficiency.

There remains a need for simple, low-cost, efficient methods for inhibiting bromate formation in ozonized waters, without compromising oxidation or disinfection efficiency.

### SUMMARY

In one aspect, the invention provides a method for inhibiting the formation of bromate (BrO₃⁻) from bromide ion in water during ozone treatment of said water, by adding to said water a water-soluble compound of formula I:

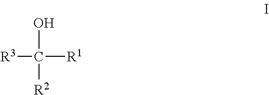

where each of R¹ and R² is an oxygen-containing electron-withdrawing substituent effective to resonance stabilize an alkoxy radical of compound I, and R³ is an aryl, aralkyl, or, preferably, an alkyl group. In selected embodiments, R³ is unsubstituted or substituted with a group selected from an amine or a further electron-withdrawing substituent. Preferably, R³ is an unsubstituted alkyl group, preferably a lower alkyl group, such as a methyl group.

The oxygen-containing electron-withdrawing substituent typically includes two or three oxygen atoms connected to a common atom selected from carbon, sulfur, and phosphorus, with at least one double bonded oxygen; as in, e.g., carboxylic, sulfonic, or phosphonic acids, or their corresponding salts. As noted below, reference herein to an “acid” includes the protonated acid form and/or any water-soluble salt form of the acid.

In selected embodiments, each of R¹ and R² is phosphonic acid or (less preferably) a hydrolyzable derivative thereof, such as an ester, or carboxylic acid or (less preferably) a hydrolyzable derivative thereof. In one embodiment, both R¹ and R² are phosphonic acid. Exemplary compounds of this class include those in which R³ is C₁-C₃ alkyl; one such compound, where R³ is methyl, is 1-hydroxyethylidene-1,1-diphosphonic acid (HEDP).

In other embodiments, both R¹ and R² are carboxylic acid or (less preferably) a hydrolyzable derivative thereof. Exemplary compounds of this class include those in which both R¹ and R² are carboxylic acid and R³ is C₁-C₃ alkyl. One such compound, where R³ is methyl, is 2-hydroxy-2-methyl malonic acid.

Compounds of formula I in which one or more of R¹, R², and R³ are carboxylic, sulfonic, or phosphonic acid tend to have highly water-soluble alkali metal, alkaline earth metal, or alkyl ammonium salts. In selected embodiments, alkali metal salts, such as sodium or potassium salts, are used.

In various embodiments, the compound of formula I is added to the water concurrently with the ozone treatment, or preceding the ozone treatment, or following the ozone treatment. Typically, the compound of formula I is added to the water concurrently with or preceding the ozone treatment.

Preferably, the compound of formula I is added to the water in an amount effective to measurably inhibit bromate formation, without significantly impeding the oxidation of contaminants or destruction of pathogens (i.e. disinfection) in the water by the ozone treatment. For example, the compound of formula I can be added to the water in an amount effective to inhibit bromate formation by 15% or more, or by 25%, 50%, 75%, 95% or more.

Other oxidizing species, such as hydrogen peroxide and/or UV radiation, may also be added to the water. The compound of formula I may be added to the water concurrently with, preceding, or following hydrogen peroxide treatment. Typically, the compound of formula I is added to the water concurrently with or preceding hydrogen peroxide treatment.

The compound of formula I may be added as an additive which comprises one or more compounds of formula I; as an additive consisting essentially of one or more compounds of formula I; as an additive consisting essentially of one or more compounds of formula I in combination with a solvent or carrier, such as water; as an additive consisting of one or more compounds of formula I; or as an additive consisting of one or more compounds of formula I in combination with a solvent or carrier, such as water.

In typical applications of the method, bromide is known to be present in the water being treated, and inhibition of bromate formation is desired. The method may further comprise monitoring bromate level in the water being treated; e.g. by measuring bromate level in the water before, during, and/or after treatment with ozone and a compound of formula I.

In accordance with the disclosed method, also disclosed is a system or apparatus for treating water, which includes structure for adding ozone to the water, in accordance with known methods, and structure for adding a compound of formula I to the water. The system or apparatus may also include structure for adding hydrogen peroxide to the water.

### BRIEF DESCRIPTION OF THE DRAWINGS

FIG. 1 shows inhibition of bromate formation by a composition containing HEDP (1-hydroxyethylidene-1,1-diphosphonic acid, also termed etidronic acid) in oxidation of water using ozone and two different levels of hydrogen peroxide; and

FIG. 2 shows the minimal effect of HEDP on oxidation efficiency.

### DETAILED DESCRIPTION

### I. Definitions

In the description and claims set forth herein, the following terminology is used in accordance with the definitions below.

“Alkyl” refers to a saturated hydrocarbon chain, typically ranging from about 1 to 12 carbon atoms in length, more typically about 1 to 6 carbon atoms in length (lower alkyl), preferably 1 to 3 carbon atoms in length. Such hydrocarbon chains may be branched or, more typically, linear. Exemplary alkyl groups include ethyl, propyl, isopropyl, butyl, pentyl, 3-methylpentyl, and the like. As used herein, “alkyl” includes cycloalkyl having three or more carbon atoms, typically three to six carbon atoms.

The term “aryl” refers to a monovalent aromatic group having a single ring (e.g., phenyl) or fused rings (e.g., naphthalene). Unless otherwise defined, such aryl groups typically contain from 4 to 10 carbon ring atoms. Multiple aryl rings may be fused, as in naphthyl, or unfused (linked), as in biphenyl. Aryl rings may also be fused or linked with one or more cyclic non-aryl hydrocarbon, non-aryl geterocyclic, or heteroaryl rings. Hydrocarbon aryl groups (i.e. not containing heteroatoms) are generally preferred. Representative aryl groups include phenyl, naphthalene-1-yl, naphthalene-2-yl, and the like.

“Aralkyl” refers to an alkyl, preferably lower (C₁-C₄, more preferably C₁-C₂)alkyl, substituent which is further substituted with an aryl group; examples are benzyl and phenethyl.

As used herein, “aryl” includes heteroaryl, which refers to a monovalent aromatic group containing in the ring at least one heteroatom (typically 1 to 3 heteroatoms) selected from nitrogen, oxygen and sulfur. Heteroaryl rings may also be fused with one or more cyclic hydrocarbon, heterocyclic, aryl, or heteroaryl rings. Unless otherwise defined, such heteroaryl groups typically contain from 5 to 10 total ring atoms. Representative heteroaryl groups include, by way of example, monovalent species of pyrrole, imidazole, thiazole, oxazole, furan, thiophene, triazole, pyrazole, isoxazole, isothiazole, pyridine, pyrazine, pyridazine, pyrimidine, triazine, indole, benzofuran, benzothiophene, benzimidazole, benzthiazole, quinoline, isoquinoline, quinazoline, quinoxaline, and the like.

Reference to an “acid”, such as a phosphonic, sulfonic, or carboxylic acid, includes any water-soluble (at room temperature) salt form of the acid. The relative concentration of salt and acid in aqueous solution is dependent on pH, as known to those skilled in the art.

“Oxidants” refer to oxidizing reagents added to water, such as ozone and/or hydrogen peroxide, as well as reactive species generated thereby, such as hydroxyl radicals.

“Inhibition” of bromate formation by a compound is said to occur when the resulting amount of bromate observed in the water being treated is less than would have been observed in the absence of the compound, irrespective of mechanism. Inhibition, in one sense, entails preventing bromide from being converted to bromate. Alternatively, if bromide is converted to bromate, but the bromate formed is then removed (e.g. by conversion to a different species), such a result would also fall under the term “inhibition”.

### II. Method for Inhibiting Bromate Formation in Ozonation Processes

It has been discovered that the addition of a compound of formula I to water that is undergoing treatment with ozone and/or hydrogen peroxide is effective to inhibit bromate formation, without significantly impeding desired oxidation of contaminants and/or destruction of pathogens in the water by the oxidant(s).

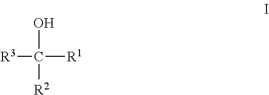

In compounds of formula I, R¹ and R² are oxygenated electron-withdrawing substituents effective to resonance stabilize an alkoxy radical of compound I (i.e. the radical ⁻OC(R¹)(R²)(R³)), and R³ is an alkyl, aryl, or aralkyl group, preferably an alkyl group.

In selected embodiments, alkyl is lower alkyl, more preferably C₁-C₃ alkyl, and most preferably methyl. Aryl is preferably hydrocarbon aryl (i.e. non-heteroaryl) and more preferably phenyl; aralkyl is preferably benzyl or phenethyl and most preferably benzyl. The alkyl, aryl, or aralkyl group may be substituted with a group selected from an amine, a further electron-withdrawing substituent as defined for R¹ and R² below, and (for aryl and aralkyl) C₁-C₃ alkyl. In selected embodiments, the alkyl, aryl, or aralkyl group is unsubstituted or (for aryl and aralkyl) substituted with C₁-C₃ alkyl.

R¹ and R² are preferably selected from phosphonic acid (or phosphonate) and carboxylic acid (or carboxylate) substituents. In one embodiment, R¹ and R² are both phosphonic acid, and in another embodiment, R¹ and R² are both carboxylic acid. Hydrolyzable derivatives (such as esters) of phosphonic and carboxylic acids are also included, although the acid (which may be in salt form, as noted above) is preferred.

Preferred embodiments of formula I include 1-hydroxyethylidene-1,1-diphosphonic acid (HEDP) (II) and 2-hydroxy-2-methyl malonic acid (III). Preferred salt forms include the sodium and potassium salts.

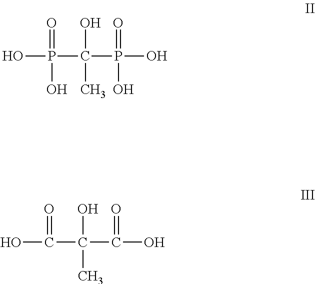

Hydroxyl radicals formed in oxidation reactions using ozone and/or hydrogen peroxide will convert the compound of formula I to its alkoxy radical. As noted above, the alkoxy radical is resonance stabilized, by delocalization of the free electron to the oxygen atoms of the electron-withdrawing groups, as illustrated for one of the phosphonate groups of compound II in the scheme below.

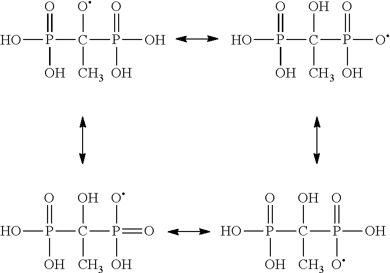

While not being bound by theory, it is assumed that the compound of formula I thus serves to buffer the highly reactive hydroxyl radical and thereby reduce conversion of bromide ion to bromate.

Addition of ozone and/or hydrogen peroxide to water can be carried out according to methods known in the art. See e.g. ozonation processes described and referenced in U.S. Pat. Nos. 5,851,407 and 6,024,882, U.S. Patent Appn. Pubn. Nos. 2008/0290045 and 2009/0032471, and PCT Pubn. Nos. WO 2009/128916 and WO 2009/117141, each of which is incorporated herein by reference in its entirety. In particular, U.S. Pat. Nos. 5,851,407 and 6,024,882 describe a high pressure advanced oxidation process (AOP), referred to as HiPOx™ in which injection of hydrogen peroxide is followed by the repeated injection of doses of ozone, at a pressure, velocity, and direction approximately matching that of the water flow. Ozone may also be employed alone, or in combination with other reagents or processes such as UV irradiation.

Preferably, the compound of formula I and the oxidant(s) are added to the water concurrently, or with the compound of formula I preceding the oxidant(s).

The method is advantageously carried out in water treatment processes employing ozone in which bromide is known to be present in the water being treated, and/or where formation of bromate is a concern and/or where reduction of bromate formation is desired. The method may further comprise steps of monitoring bromate level in the water; i.e. measuring levels of bromate in the water before, during, and/or after treatment with ozone and a compound of formula I.

The compound of formula I, or a composition containing it, is added in an amount effective to measurably inhibit bromate formation without significantly impeding the oxidation of contaminants in the water. Preferably, bromate inhibition (defined as (BL₀-BL)/BL₀, where BL₀ is the level of bromate with no additive and BL is the level with additive) is 15% or more, more preferably 25% or more, and most preferably 50% or more. In one embodiment, inhibition is effective to produce a treated water (effluent) having a bromate concentration less than 10 μg/mL.

As noted above, the compound of formula I may be added as an additive which comprises one or more compounds of formula I; as an additive consisting essentially of one or more compounds of formula I; as an additive consisting essentially of one or more compounds of formula I in combination with a solvent or carrier, such as water; as an additive consisting of one or more compounds of formula I; or as an additive consisting of one or more compounds of formula I in combination with a solvent or carrier, such as water.

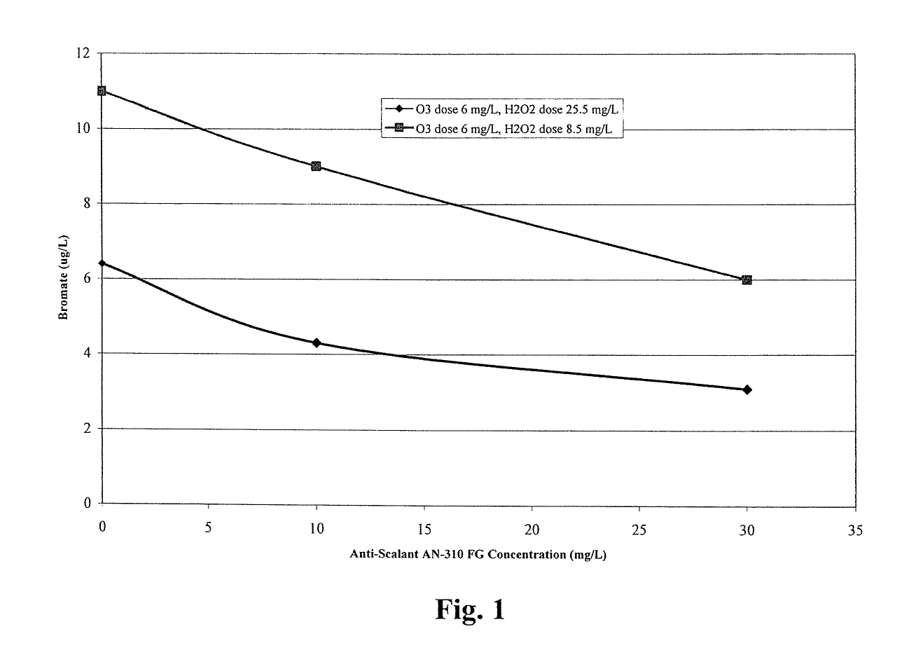

To illustrate the effectiveness of the method, the additive AN-310 FG (Analytix Technologies, Houston Tex.), which contains the compound of structure II (HEDP) in addition to a polymer dispersant and water (see further description below), was added in increasing amounts to ground water known to contain bromide and 1,4-dioxane (a groundwater contaminant), and the water was treated with ozone and hydrogen peroxide. As shown in FIG. 1, the amount of bromate produced during oxidation was found to decrease with increasing amounts of the compound.

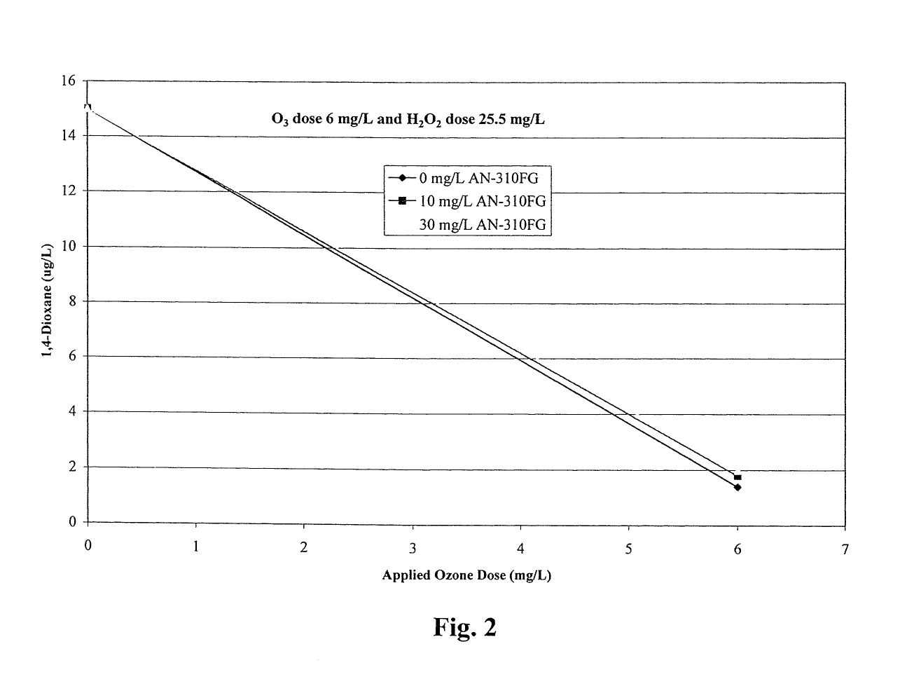

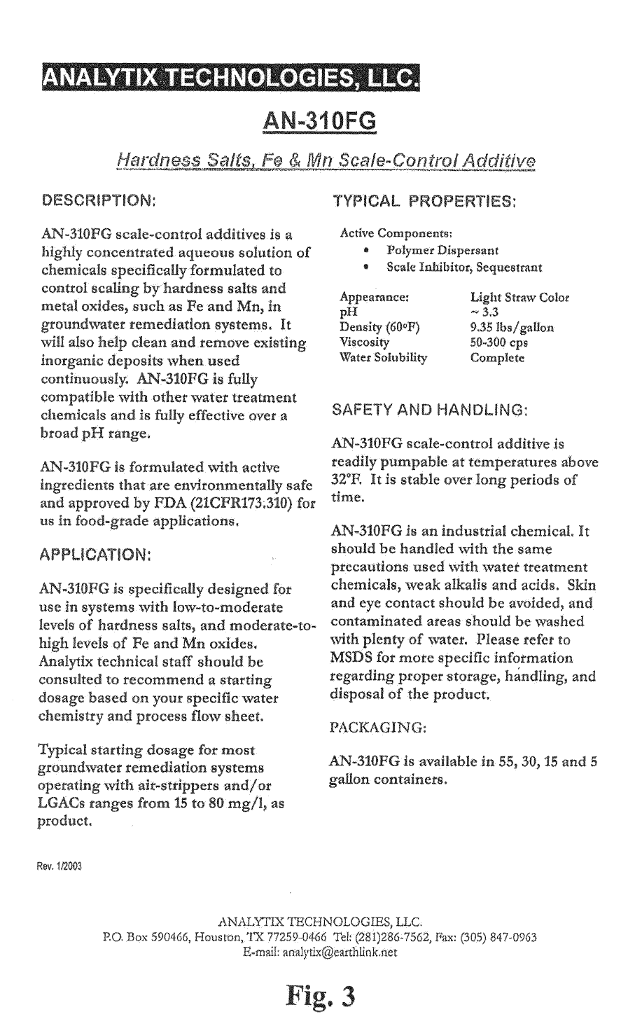

Furthermore, in contrast to hydroxyl radical scavengers such as tert-butyl alcohol, which produces a highly reactive alkoxide radical, addition of the compound of formula I does not significantly interfere with the desirable oxidizing capacity of the ozone and/or hydrogen peroxide in the system. As shown by the data in FIG. 2, the presence of the compound did not significantly impede the oxidation of the contaminant, 1,4-dioxane.

The additive AN-310FG is described by the supplier (Analytix Technologies) as “a highly concentrated aqueous solution of chemicals specifically formulated to control scaling by hardness salts and metal oxides, such as Fe and Mn, in groundwater remediation systems.” Its active ingredients, given as “polymer dispersant” and “scale inhibitor, sequestrant”, are described as “environmentally safe and approved by FDA (21CFR173; 310) for use in food-grade applications.” For conventional use, the typical starting dosage is described as “15 to 80 mg/l, as product.” Typical properties are given as pH ˜3.3, density at 60° C. 9.35 lb/gallon, viscosity 50-300 cps, and complete water solubility.

The dispersant in the additive AN-310 FG was assumed to be an an acrylic acid tetramer, which is very commonly used in combination with HEDP in formulations designed to reduce metal deposits (scale). On this basis, the inventors determined, via elemental analysis, that the AN-310 FG additive that was employed contained about 10% by weight of HEDP, about 10% by weight of the dispersant, and the remainder water.

Further experiments employing HEDP alone, without the dispersant, showed a similar effect, in which bromate formation was inhibited, without adversely effecting oxidizing efficiency. These experiments employed ozone in combination with hydrogen peroxide, as in the experiments shown in FIG. 1.

The disclosed method is applicable to treatment of any water source that is known to contain, or may contain, bromide ion and that is to be treated with ozone. Such water sources may include, for example, industrial or municipal wastewaters, process waters, ground water, or drinking water. Ozone treatment, alone or in combination with other treatments such as hydrogen peroxide or UV radiation, can be used for destruction of chemical contaminants, both organic and inorganic, as well as destruction of pathogens, such as viruses and bacteria.

In accordance with the disclosed method, also disclosed is a water treatment apparatus, reactor, or system, which includes structure for adding ozone to the water, e.g. an ozone generator and suitable conduits, and structure for adding a compound of formula I to the water, both downstream of a source of influent water to the apparatus. The compound(s) of formula I may be added either upstream or downstream of an ozone inlet, or concurrently with the ozone, but via a separate inlet. Typically, the compound(s) of formula I are added either upstream or concurrently with the ozone.

These and other applications and implementations of the disclosed system and method will be apparent in view of the disclosure. Such modifications, substitutions and alternatives can be made without departing from the spirit and scope of the invention, which should be determined from the appended claims.

1. A method for inhibiting the formation of bromate (BrO₃⁻) from bromide ion in water during ozone treatment of said water, by adding to said water a compound of formula I: 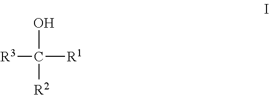
where each of R¹ and R² is an oxygen-containing electron-withdrawing substituent effective to resonance stabilize an alkoxy radical of compound I, and R³ is an alkyl, aryl, or aralkyl group.

2. The method of claim 1, wherein R³ is an alkyl group.

3. The method of claim 2, wherein R³ is unsubstituted or is substituted with a group selected from an amine or a further electron-withdrawing substituent.

4. The method of claim 3, wherein R³ is unsubstituted.

5. The method of claim 4, wherein R³ is a methyl group.

6. The method of claim 1, wherein each of R¹ and R² is selected from phosphonic acid and carboxylic acid.

7. The method of claim 6, wherein both R¹ and R² are phosphonic acid.

8. The method of claim 7, wherein R³ is C₁-C₃ alkyl.

9. The method of claim 8, wherein R³ is methyl, such that the compound of formula I is 1-hydroxyethylidene-1,1-diphosphonic acid (HEDP).

10. The method of claim 6, wherein both R¹ and R² are carboxylic acid.

11. The method of claim 10, wherein R³ is C₁-C₃ alkyl.

12. The method of claim 11, wherein R³ is methyl, such that the compound of formula I is 2-hydroxy-2-methyl malonic acid.

13. The method of claim 1, wherein the compound of formula I is added to said water concurrently with said ozone treatment or preceding said ozone treatment.

14. The method of claim 1, wherein the compound of formula I is added to said water in an amount effective to measurably inhibit bromate formation without significantly reducing the level of oxidation of contaminants or disinfection of pathogens in the water by said ozone treatment.

15. The method of claim 1, wherein hydrogen peroxide is also added to said water.

16. The method of claim 1, wherein bromide is known to be present in the water being treated.

17. The method of claim 1, which further comprises monitoring bromate level in the water being treated.

18. The method of claim 17, wherein said monitoring comprises measuring bromate level in the water before, during, and/or after treatment with ozone and a compound of formula I.

19. An apparatus for treating water, comprising structure for adding ozone to the water and structure for adding a compound of formula I, as defined in claim 1, to the water.
